(19) United States
(12) Patent Application Publication
(10) Pub. No.: US 2014/0201506 A1
(43) Pub. Date: Jul. 17, 2014

(54) METHOD FOR DETERMINING INSTRUCTION ORDER USING TRIGGERS

(71) Applicants: Angshuman Parashar, Hudson, MA (US); Michael Pellauer, Cambridge, MA (US); Michael Adler, Newton, MA (US); Joel Emer, Hudson, MA (US)

(72) Inventors: Angshuman Parashar, Hudson, MA (US); Michael Pellauer, Cambridge, MA (US); Michael Adler, Newton, MA (US); Joel Emer, Hudson, MA (US)

(21) Appl. No.: 13/997,021

(22) PCT Filed: Dec. 30, 2011
(86) PCT No.: PCT/US11/68117

§ 371 Date: Jun. 21, 2013

(51) Int. Cl. G06F 9/30

(52) U.S. Cl. CPC G06F 9/30145
USPC 712/229

(57) ABSTRACT

A processing engine includes separate hardware components for control processing and data processing. The instruction execution order in such a processing engine may be efficiently determined in a control processing engine based on inputs received by the control processing engine. For each instruction of a data processing engine: a status of the instruction may be set to “ready” based on a trigger for the instruction and the input received in the control processing engine; and execution of the instruction in the data processing engine may be enabled if the status of the instruction is set to “ready” and at least one processing element of the data processing engine is available. The trigger for each instruction may be a function of one or more predicate register of the control processing engine, FIFO status signals or information regarding tags.

### BACKGROUND INFORMATION

Computer systems may often include accelerators built for computationally intensive workloads, e.g. media encoding/decoding, signal processing, sorting, pattern matching, compression or cryptography. These accelerators often include a large number of processing elements arranged as a grid, with each element of the grid being a small processor that executes a standard, sequential program stream. The processing of the sequential program may be viewed as requiring operations separated into two distinct classes: control processing operations and data processing operations. In a standard processor, both the control and data processing streams are handled as instructions dispatched to and executed in the execution logic of the processor.

However, this can lead to several inefficiencies. For example, in a conventional processor a large number of instructions are devoted solely to computing what the next set of instructions should be (i.e. which instructions are “ready”), from where data should be retrieved and to where data may be stored. If instead a programmer describes a pool of operations that execute based on the arrival of certain patterns of inputs then it is possible to separate out the computation of which instructions are “ready” into a parallel circuit that may improve performance dramatically by avoiding instruction-level polling of data sources.

### BRIEF DESCRIPTION OF THE DRAWINGS

FIG. 1 is a block diagram of the micro-architecture for a processing engine in accordance with an example embodiment of the present invention.

FIG. 2 is a flow chart of a method for determining instruction order according to an example embodiment of the present invention.

FIGS. 3A and 3B illustrate example predicate registers used for determining the order of execution for instructions in an example processing engine according to the present invention.

FIGS. 3C and 3D illustrate example triggers used for determining the order of execution for instructions in an example processing engine according to the present invention.

FIGS. 3E and 3F illustrate example Boolean functions of predicate registers and other information that may represent example triggers used for determining the order of execution for instructions in an example processing engine according to the present invention.

FIG. 4 is a block diagram of a system according to an embodiment of the present invention.

### DETAILED DESCRIPTION OF EXAMPLE EMBODIMENTS

Embodiments of the present invention avoid the standard sequential programming model for a processor by providing separate hardware components for control processing and data processing. The instruction execution order in a processing engine according to the present invention can be efficiently determined by receiving input in a control processing engine and, for each instruction of a data processing engine, setting a status of the instruction to “ready” based on a trigger for the instruction and the input received in the control processing engine. Execution of the instruction in the data processing engine may be enabled if the status of the instruction is set to “ready” and at least one processing element of the data processing engine is available to execute the instruction. In one example embodiment, the instructions may then be decoded into micro instructions or nano instructions before they are executed in the data processing engine. The trigger for each instruction may be implemented by a programmer as a function of at least one predicate register of the control processing engine, FIFO status signals from one or more FIFOs (e.g. FIFO[0], FIFO[1] etc. used for inbound/outbound data) and tags (metadata) that either arrive over FIFOs, or are already present in registers inside the processing engine.

This may provide several advantages for a processor, especially in the context of an accelerator. For example: control decisions that may have taken multiple instruction cycles on a standard PC-based architecture may now be computed in a single cycle, control processing for multiple instructions may be computed in parallel if multiple instructions are ready to be executed and processing elements are available, and multiple algorithms may be mapped to a single processing element and executed by the processing element in an interleaved manner.

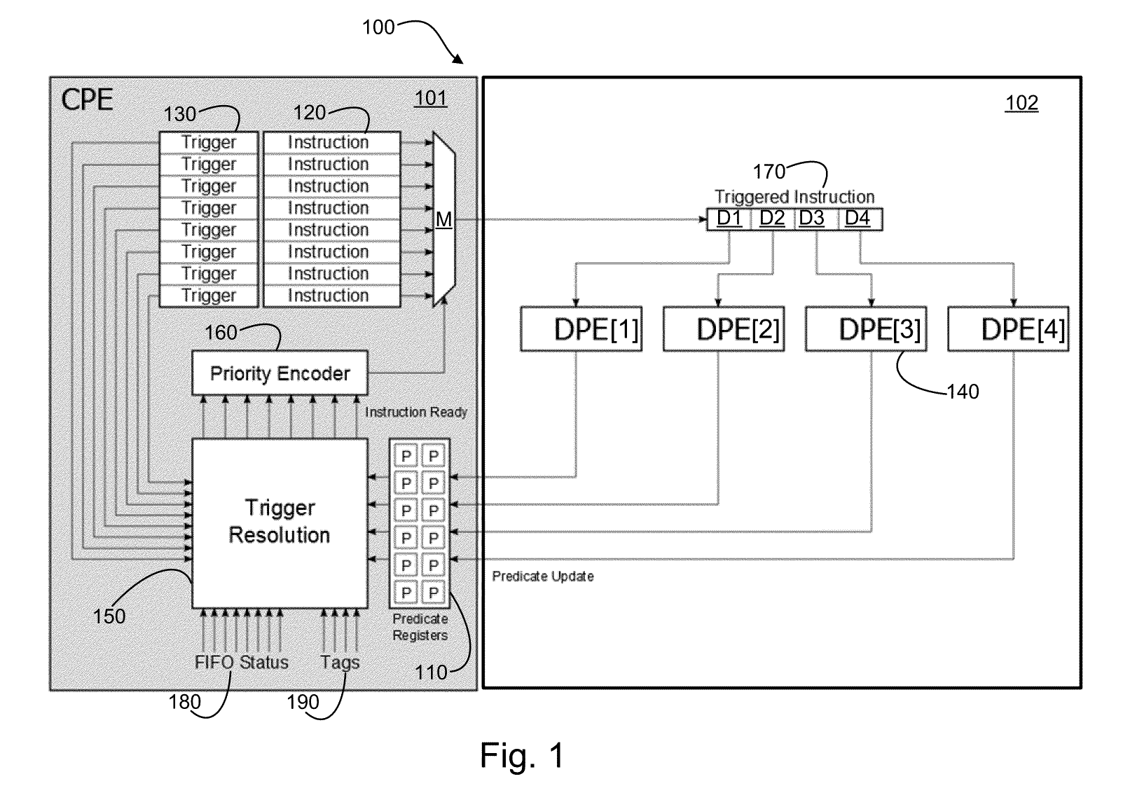

FIG. 1 is a block diagram of the micro-architecture for a processing engine in accordance with an example embodiment of the present invention. A processing engine 100, for example an accelerator, may be fed by one or more sources of inbound, external data (e.g. FIFOs, not shown) and the processing engine may have one or more outbound pathways for writing outbound data (also not shown). The processing engine 100 may define two separate classes of operations: control and data; and may include separate hardware for executing the separate control and data operations. A control processing engine 101 (CPE) may receive inputs (110, 180, and/or 190) which may be used to determine when to enable data processing instructions 120 to be executed in a data processing engine 102 (DPE). Using input received in the CPE 101, when and in what order instructions 120 are executed in the DPE 102 may be efficiently determined. Triggers 130 of CPE 101 may represent requirements for the execution of instructions 120 in the DPE 102 and may, for example, be based on the availability of inbound data, the availability of space for writing outbound data, values of inbound data, or values of internal registers. Triggers 130 may be composed of functions of multiple inputs received in the CPE 101, for example a Boolean function of predicate registers 110. The CPE 101 includes a set of instructions 120 that are executed in the DPE 102. These instructions 120 may, for example, read inbound data, that operate on data, update local states (e.g. write data registers in the DPE and/or predicate registers 110 in the CPE) or write outbound data, however the instructions 120 have no intrinsic order in the DPE 102. Data processing elements (DPE[1] to DPE[4]) 140 of the DPE 102 may have local storage, such as registers. Data from the processing elements 140 of the DPE 102 is transmitted to CPE 101 and the predicate registers 110 of CPE 101 are updated based on this information. A trigger resolution module 150 compares the input received in the CPE 101 with information regarding respective triggers 130 for each of the instructions 120 in order to determine if a status of each instruction 120 should be set to “ready”.

A trigger 130 is a function that may be implemented by a programmer, e.g. a Boolean function. The function specification for each trigger 130 is stored alongside each instruction 120 in the CPE's instruction storage. The function may be a Boolean expression of predicate registers 110, FIFO status signals 180, and/or comparisons of tags 190 against target values or other tags. Predicate registers 110 and FIFO status signals 180 may themselves be Boolean (true/false) values and can therefore be fed directly into a Boolean function. Tags, however, may be multi-bit values. Therefore a comparison of a tag against an equal bit-width target value or other tag may be used for a true/false signal that can be fed into the Boolean expression in the trigger function. Alternatively comparison of a single bit or a bit mask in a tag against a target value or a true/false test for a single bit or a bit mask in a tag being less than/greater than some value could be used. For example, trigger[3]=pred[0] && !pred[1] && fifo[0].notEmpty && (fifo[0].tag==1010) describes the conditions under which Instruction[3] in storage 120 is allowed to execute. In the situation where a trigger 130 is a function of FIFO status signals 180 or comparisons of tags 190, the trigger resolution module 150 may compute the output of each trigger 130 based on the input from predicate registers 110 of CPE 101 and the FIFO status signals 180 or comparisons of tags 190 in order to determine if a status of each instruction 120 should be set to “ready”.

FIFOs are used commonly in electronic circuits for buffering and flow control. In hardware form a FIFO primarily consists of a set of read and write pointers, storage and control logic. Storage may be SRAM, flip-flops, latches or any other suitable form of storage. Examples of FIFO status flags include: full, empty, almost full, almost empty, etc. Tags are used commonly for adding metadata to data, for example metadata associated with an algorithm indicating a source of the data. If two sources write to the same FIFO, a tag could be used to determine which source wrote a particular value. As mentioned above, tags may be multi-bit values: e.g. 1010.

An additional embodiment may provide architectural (hardware) support to guarantee that empty FIFOs are never read and full FIFOs are never written. In this case, the FIFO status signals 180 may not be made visible to the programmer. Instead, the hardware may infer these conditions by looking at the input and output FIFOs an instruction may attempt to read or write to when it is executed. In this case, the hardware may automatically add the appropriate not full or not empty trigger inputs to the trigger function specified by the programmer. Thus, an instruction that may attempt to read an empty FIFO or write a full FIFO will never be selected for execution because its trigger will evaluate to false, i.e. not “ready”.

A priority encoder 160 may enable instructions 120 with a “ready” status to be executed by processing elements 140 of DPE 102 if at least one processing element 140 of DPE 102 is available to execute the instruction. In one example embodiment, the enabled instruction (triggered instruction 170) may be selected for execution by a multiplexer M and then it may be decoded into micro instructions or nano instructions D1-D4 before being executed by processing elements 140 of DPE 102.

Parallel processing in trigger resolution module 150 of all the functions of triggers 130 that may trigger instructions 120 may reduce the time required to choose instructions that are ready to be executed to a single cycle of the processing engine 100 and the ordering execution of the triggered instructions 120 may automatically correspond to the arrival of inbound data needed for further execution.

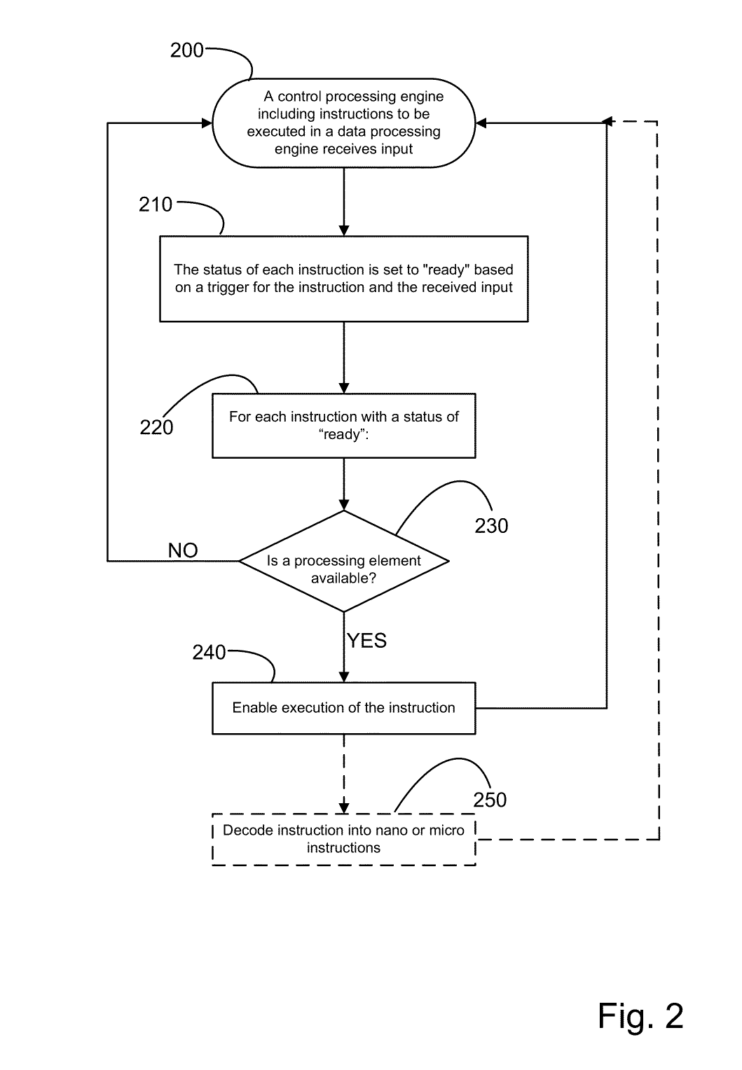

FIG. 2 is a flow chart of a method for determining instruction order according to an example embodiment of the present invention. In a first operation 200, data from at least one input (predicate register 110 of the CPE 101, FIFO status signals 180 or a comparison of tags 190) is received by CPE 101. In operation 210, the status of each instruction 120 of the DPE 102 is set to “ready” by trigger resolution module 150 based on a trigger 130 for the instruction 120 and the received input. In operations 220 and 230, each instruction 120 that has a status of “ready” may be enabled for execution in the DPE 102 by the priority encoder 160 if at least one processing element of DPE 102 is available to execute the instruction. If no processing elements of DPE 102 are available then the CPE 101 receives new input in the next processing cycle. In operation 240 a instruction 120 that has a status of “ready” and for which there is at least one processing element of DPE 102 available is enabled as triggered instruction 170. If no further “ready” instructions are available then the CPE 101 receives new input in the next processing cycle. In optional operation 250, the enabling may include decoding the triggered instruction 170 by into micro instructions or nano instructions D1-D4 to be executed by processing elements 140 of DPE 102, after it is selected for execution by a multiplexer M. The CPE 101 then receives new input in the next processing cycle.

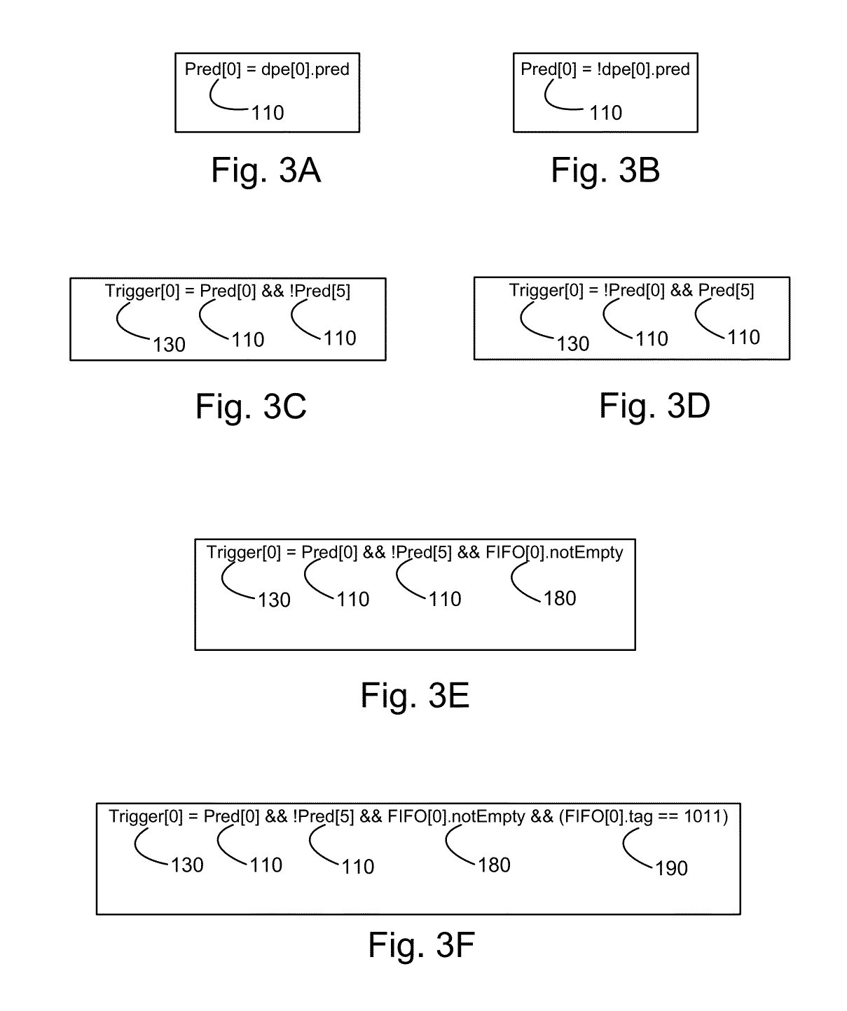

FIGS. 3A to 3F show example predicate registers 110 and triggers 130 of CPE 101 used for determining the order of execution for instructions 120 in an example processing engine 100 according to the present invention. In FIGS. 3A to 3F the example predicate registers 110 and triggers 130 may be Boolean functions of information received by the CPE 101.

FIGS. 3A and 3B illustrate example predicate registers 110 used for determining the order of execution for instructions 120 in an example processing engine 100 according to the present invention. In FIG. 3A, an example predicate register 110 of CPE 101: Pred[0] may be a function (e.g. Boolean) of information received from at least one processing element 140 of DPE 102: the value dpe[0].pred, in the example it is equal to the value (which could have a more generic notation such as “X”). Another example predicate register 110: Pred[0], as shown in FIG. 3B, may be equal to the value !dpe[0].pred (e.g., “not X” or the inverse of “X”).

FIGS. 3C and 3D illustrate example Boolean functions of predicate registers 110 of CPE 101 that may represent example triggers 130 used for determining the order of execution for instructions 120 in an example processing engine 100 according to the present invention. In FIG. 3C, example trigger 130 of CPE 101: Trigger[0] may be a function (e.g. Boolean) of predicate registers 110 of CPE 101: Pred[0] and Pred[5], in the example it is equal to Pred[0] && !Pred[5] (which may be equal to a logical AND of information received by the CPE 101 from at least one processing element 140 of DPE 102, as described above). In FIG. 3D, example trigger 130 of CPE 101: Trigger[0] may be a function (e.g. Boolean) of predicate registers 110 of CPE 101: Pred[0] and Pred[5], in the example it is equal to the inverse of the trigger in FIG. 3C: !Pred[0] && Pred[5] (which may be equal to a logical AND of information received by the CPE 101 from at least one processing element 140 of DPE 102, as described above).

FIGS. 3E and 3F illustrate example triggers 130 used for determining the order of execution for instructions 120 in an example processing engine 100 according to the present invention. In FIG. 3E, example trigger 130 of CPE 101: Trigger[0] may be a function (e.g. Boolean) of predicate registers 110 of CPE 101: Pred[0] and Pred[5], and FIFO status signals 180: FIFO.notEmpty, in the example it is equal to Pred[0] && !Pred[5] && FIFO[0].notEmpty. In FIG. 3F, example trigger 130 of CPE 101: Trigger[0] may be a function (e.g. Boolean) of predicate registers 110 of CPE 101: Pred[0] and Pred[5], FIFO status signals 180: FIFO.notEmpty, and a comparison of tags 190:FIFO[0].tag to a target value or to another tag 190, in the example it is equal to Pred[0] && !Pred[5] && FIFO[0].notEmpty && (FIFO[0].tag==1011).

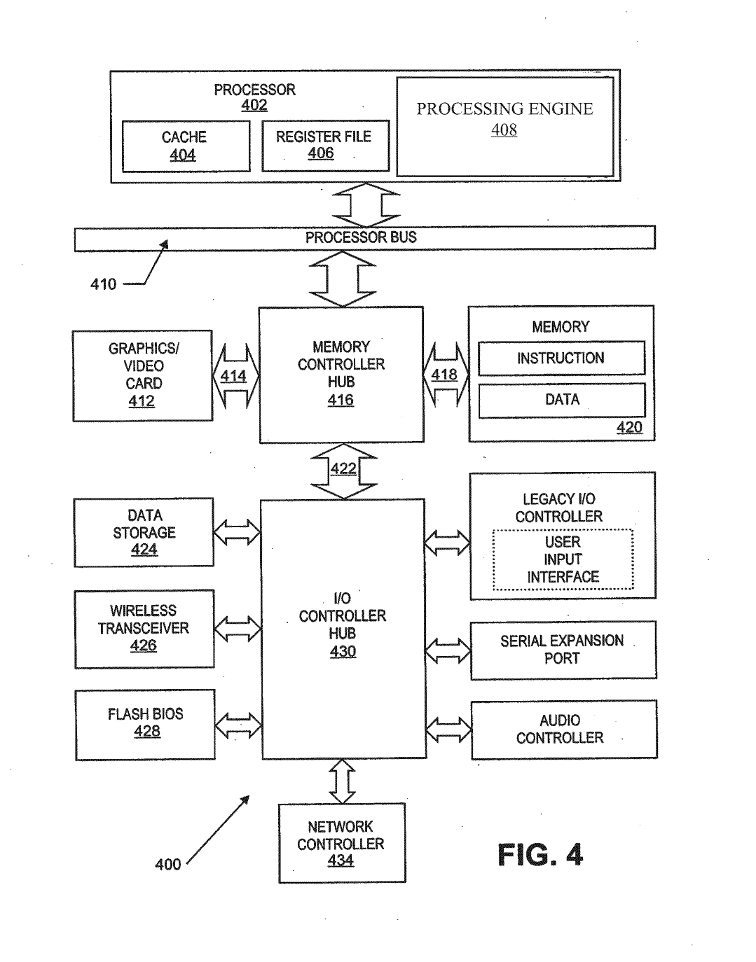

FIG. 4 is a block diagram of an exemplary computer system formed with a processor as described above. System 400 includes a processor 402 (that includes a processing engine 408 such as processing engine 100) which can process data, in accordance with the present invention, such as in the embodiment described herein. System 400 is representative of processing systems based on the PENTIUM® III, PENTIUM® 4, Xeon™, Itanium®, XScale™ and/or StrongARM™ microprocessors available from Intel Corporation of Santa Clara, Calif., although other systems (including PCs having other microprocessors, engineering workstations, set-top boxes and the like) may also be used. In one embodiment, sample system 400 may execute a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

Embodiments are not limited to computer systems. Alternative embodiments of the present invention can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

FIG. 4 is a block diagram of a computer system 400 formed with processor 402 that includes a processing engine 408 to perform an algorithm to perform at least one instruction in accordance with one embodiment of the present invention. One embodiment may be described in the context of a single processor desktop or server system, but alternative embodiments can be included in a multiprocessor system. System 400 is an example of a ‘hub’ system architecture. The computer system 400 includes a processor 402 to process data signals. The processor 402 is coupled to a processor bus 410 that can transmit data signals between the processor 402 and other components in the system 400. The elements of system 400 perform their conventional functions that are well known to those familiar with the art.

In one embodiment, the processor 402 includes a Level 1 (L1) internal cache memory 404. Depending on the architecture, the processor 402 can have a single internal cache or multiple levels of internal cache. Alternatively, in another embodiment, the cache memory can reside external to the processor 402. Other embodiments can also include a combination of both internal and external caches depending on the particular implementation and needs. Register file 406 can store different types of data in various registers including integer registers, floating point registers, status registers, and instruction pointer register.

Alternate embodiments of a processing engine 408 can also be used in micro controllers, embedded processors, graphics devices, DSPs, and other types of logic circuits. System 400 includes a memory 420. Memory 420 can be a dynamic random access memory (DRAM) device, a static random access memory (SRAM) device, flash memory device, or other memory device. Memory 420 can store instructions and/or data represented by data signals that can be executed by the processor 402.

A system logic chip 416 is coupled to the processor bus 410 and memory 420. The system logic chip 416 in the illustrated embodiment is a memory controller hub (MCH). The processor 402 can communicate to the MCH 416 via a processor bus 410. The MCH 416 provides a high bandwidth memory path 418 to memory 420 for instruction and data storage and for storage of graphics commands, data and textures. The MCH 416 is to direct data signals between the processor 402, memory 420, and other components in the system 400 and to bridge the data signals between processor bus 410, memory 420, and system I/O 422. In some embodiments, the system logic chip 416 can provide a graphics port for coupling to a graphics controller 412. The MCH 416 is coupled to memory 420 through a memory interface 418. The graphics card 412 is coupled to the MCH 416 through an Accelerated Graphics Port (AGP) interconnect 414.

System 400 uses a proprietary hub interface bus 422 to couple the MCH 416 to the I/O controller hub (ICH) 430. The ICH 430 provides direct connections to some I/O devices via a local I/O bus. The local I/O bus is a high-speed I/O bus for connecting peripherals to the memory 420, chipset, and processor 402. Some examples are the audio controller, firmware hub (flash BIOS) 428, wireless transceiver 426, data storage 424, legacy I/O controller containing user input and keyboard interfaces, a serial expansion port such as Universal Serial Bus (USB), and a network controller 434. The data storage device 424 can comprise a hard disk drive, a floppy disk drive, a CD-ROM device, a flash memory device, or other mass storage device.

For another embodiment of a system, an instruction in accordance with one embodiment can be used with a system on a chip. One embodiment of a system on a chip comprises of a processor and a memory. The memory for one such system is a flash memory. The flash memory can be located on the same die as the processor and other system components. Additionally, other logic blocks such as a memory controller or graphics controller can also be located on a system on a chip.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art upon studying this disclosure. In an area of technology such as this, where growth is fast and further advancements are not easily foreseen, the disclosed embodiments may be readily modifiable in arrangement and detail as facilitated by enabling technological advancements without departing from the principles of the present disclosure or the scope of the accompanying claims.

1. A method for determining instruction execution order in a processing engine, the method comprising:
receiving input in a control processing engine of the processing engine; and
for each instruction of a data processing engine of the processing engine:
setting a status of the instruction to “ready” based on a trigger for the instruction and the input received in the control processing engine; and
enabling execution of the instruction in the data processing engine if the status of the instruction is set to “ready” and at least one processing element of the data processing engine is available.

2. The method of claim 1, further comprising:
updating at least one predicate register of the control processing engine based on the received input;
wherein:
the received input includes input from at least one processing element of a data processing engine; and
the trigger for each instruction is a function of the at least one predicate register of the control processing engine.

3. The method of claim 1, wherein:
the received input includes at least one FIFO status signal; and
the trigger for each instruction is a function of the at least one FIFO status signal.

4. The method of claim 1, wherein:
the received input includes at least one tag; and
the trigger for each instruction is a function of a comparison of the at least one tag to a target value or to another tag.

5. The method of claim 2, wherein:
the received input includes at least one FIFO status signal; and
the trigger for each instruction is a function of the at least one FIFO status signal.

6. The method of claim 2, wherein:
the received input includes at least one tag; and
the trigger for each instruction is a function of a comparison of the at least one tag to a target value or to another tag.

7. The method of claim 3, wherein:
the received input includes at least one tag; and
the trigger for each instruction is a function of a comparison of the at least one tag to a target value or to another tag.

8. The method of claim 1, wherein the setting and enabling for each instruction of the data processing engine is performed in one clock cycle of the processing engine.

9. The method of claim 1, wherein the enabling includes decoding the instruction into micro instructions or nano instructions.

10. The method of claim 1, further comprising:
for each instruction of the data processing engine:
enabling execution of the instruction in the data processing engine if the execution of the instruction does not include writing data to a FIFO of the processing engine with a status of “full” or reading data from a FIFO of the processing engine with a status of “empty”.

11. A processing engine, comprising:
a data processing engine with at least one processing element;
a control processing engine including at least one predicate register;
a trigger resolution module that, for each instruction of the data processing engine, sets a status of the instruction to “ready” based on a trigger for the instruction and input received in the control processing engine; and
a priority encoder that, for each instruction of the data processing engine, enables execution of the instruction in the data processing engine if the status of the instruction is set to “ready” and at least one processing element of the data processing engine is available.

12. The processing engine of claim 11, wherein:
the received input includes input from at least one processing element of a data processing engine;
the at least one predicate register of the control processing engine is updated based on the received input; and
the trigger for each instruction is a function of the at least one predicate register of the control processing engine.

13. (canceled)

14. (canceled)

15. The processing engine of claim 12, wherein:
the received input includes at least one FIFO status signal; and
the trigger for each instruction is a function of the at least one FIFO status signal.

16. (canceled)

17. The processing engine of claim 13, wherein:
the received input includes at least one tag; and
the trigger for each instruction is a function of a comparison of the at least one tag to a target value or to another tag.

18. The processing engine of claim 11, wherein the trigger resolution module sets the status and the priority encoder enables the execution for each instruction of the data processing engine in one clock cycle of the processing engine.

19. The processing engine of claim 11, further comprising a multiplexer;
wherein the multiplexer selects for execution at least one instruction the priority encoder has enabled and that instruction is then decoded into micro instructions or nano instructions which are executed.

20. The processing engine of claim 11, wherein the priority encoder, for each instruction of the data processing engine, enables execution of the instruction in the data processing engine if the execution of the instruction does not include writing data to a FIFO of the processing engine with a status of “full” or reading data from a FIFO of the processing engine with a status of “empty”.

21. A system for determining instruction execution order in at least one processing engine, comprising:
a memory device;
a processor including:
at least one processing engine, including:
a data processing engine with at least one processing element;
a control processing engine including at least one predicate register;
a trigger resolution module that, for each instruction of the data processing engine, sets a status of the instruction to “ready” based on a trigger for the instruction and input received in the control processing engine; and
a priority encoder that, for each instruction of the data processing engine, enables execution of the instruction in the data processing engine if the status of the instruction is set to “ready” and at least one processing element of the data processing engine is available.

22. The system of claim 21, wherein:
the received input includes input from at least one processing element of a data processing engine;
the at least one predicate register of the control processing engine is updated based on the received input; and
the trigger for each instruction is a function of the at least one predicate register of the control processing engine.

23. (canceled)

24. (canceled)

25. The system of claim 22, wherein:
the received input includes at least one FIFO status signal; and
the trigger for each instruction is a function of the at least one FIFO status signal.

26. The system of claim 22, wherein:
the received input includes at least one tag; and
the trigger for each instruction is a function of a comparison of the at least one tag to a target value or to another tag.

27. The system of claim 23, wherein:
the received input includes at least one tag; and
the trigger for each instruction is a function of a comparison of the at least one tag to a target value or to another tag.

28. The system of claim 21, wherein the trigger resolution module sets the status of each instruction of the data processing engine to “ready” and the priority encoder enables execution of each instruction in the data processing engine if the status of the instruction is set to “ready”, in one clock cycle of the processing engine.

29. The system of claim 21, wherein the at least one processing engine includes a multiplexer; and
the multiplexer selects for execution at least one instruction the priority encoder has enabled and that instruction is then decoded into micro instructions or nano instructions which are executed.

30. The system of claim 21, wherein the priority encoder, for each instruction of the data processing engine, enables execution of the instruction in the data processing engine if the execution of the instruction does not include writing data to a FIFO of the processing engine with a status of “full” or reading data from a FIFO of the processing engine with a status of “empty”.
